(19) United States
(12) Patent Application Publication
(10) Pub. No.: US 2011/0109833 A1
(43) Pub. Date: May 12, 2011

(54) LIGHTING DEVICE, DISPLAY DEVICE, TELEVISION RECEIVER AND METHOD OF MANUFACTURING LIGHTING DEVICES

(75) Inventor: Kentaroh Kamada, Osaka-shi (JP)

(73) Assignee: SHARP KABUSHIKI KAISHA, Osaka-shi, Osaka (JP)

(21) Appl. No.: 13/001,641

(22) PCT Filed: Jul. 8, 2009
(86) PCT No.: PCT/JP2009/062428

§ 371 Date: Dec. 28, 2010

(30) Foreign Application Priority Data
Jul. 16, 2008 (JP) 2008-185021

(51) Int. Cl. G02F 1/1335; F21V 21/00; H04N 5/44; H01R 43/00

(52) U.S. Cl. 349/61; 362/368; 348/725; 29/825; 348/E05.096

(57) ABSTRACT

A backlight unit 12 includes cold cathode tubes 17, a chassis 14, a stand 30, a stand mount 40, a power circuit board 61, an image processing circuit board 62 and a control circuit board 63. The chassis 14 houses the cold cathode tubes 17. The stand 30 holds the chassis 14. The stand 30 is mounted to the stand mount 40. The stand mount 40 is fixed to a surface of the chassis 14 located on a side opposite from the cold cathode tubes 17. The power circuit board 61, the image processing circuit board 62 and the control circuit board 63 are directly fixed to the stand mount 40.

### TECHNICAL FIELD

The present invention relates to a lighting device, a display device, a television receiver and a method of manufacturing lighting devices.

### BACKGROUND ART

A liquid crystal display device used as a television receiver requires a backlight unit separately from a liquid crystal panel because the liquid crystal panel does not emit light. The backlight unit is arranged behind the liquid crystal panel. It includes a metal chassis and a number of light sources (e.g., cold cathode tubes) housed in the chassis. The chassis has an opening on the liquid crystal panel side.

On the rear surface of the chassis of the backlight unit, various circuit boards, for example, a power circuit board, an image processing circuit board and a control circuit board, are mounted. The power circuit board is configured to supply power to the light sources and the liquid crystal panel. The image processing circuit board is configured to process TV signals received by a tuner for image display. The control circuit board is configured to perform image data correction or other image processing on image data input from the image processing circuit board and convert them to a form suitable for liquid crystal panel, and to output the image data and various control signals to a drive circuit of the liquid crystal panel. An example of such a liquid crystal display device is disclosed in Patent Document 1.

Patent Document 1: Japanese Published Patent Application No. 2007-116556

### Problem to be Solved by the Invention

In the production process of the above liquid crystal display device, the circuit boards are mounted in sequence to the chassis that is carried from a start to an end of the production line.

In such a production line, working areas for mounting the boards are arranged along the length direction of the production line. Therefore, a length of the production line tends to extend. Moreover, the production efficiency is not very high.

### DISCLOSURE OF THE PRESENT INVENTION

The present invention was made in view of the foregoing circumstances. An object of the present invention is to decrease a length of a production line and improve production efficiency.

### Means for Solving the Problem

A lighting device of the present invention includes a light source, a chassis, a stand, a stand mount and at least one circuit board. The chassis houses the light source. The stand holds the chassis. The stand mount is fixed to a surface of the chassis on a side opposite from the light source and to which the stand is mounted. The at least one circuit board is directly fixed to the stand mount.

Prior to mounting of the stand and the stand mount to the chassis, the circuit board is directly fixed to the stand mount to prepare the stand mount and the circuit board as a single assembly. Therefore, a step of mounting the circuit board to the chassis is not required and thus the production line can be shortened and the production efficiency can be improved.

In comparison to a lighting device provided with a dedicated assembly part for the circuit board separately from the stand mount, in which the dedicated assembly part is fixed to the chassis, weight, thickness and material cost of the lighting device of the present invention can be reduced because such a dedicated assembly part is not required.

### BRIEF DESCRIPTION OF THE DRAWINGS

FIG. 1 is a front view illustrating an example of installation of a television receiver according to a first embodiment of the present invention;

FIG. 2 is an exploded perspective view illustrating a general construction of the television receiver;

FIG. 3 is an exploded perspective view illustrating a general construction of a liquid crystal display device included in the television receiver;

FIG. 4 is a cross-sectional view of the liquid crystal display device along the short-side direction thereof;

FIG. 5 is a cross-sectional view of the liquid crystal display device along the long-side direction thereof;

FIG. 6 is a rear view illustrating a construction of a backlight unit on the rear side;

FIG. 7 is a rear view illustrating a construction of a stand included in the backlight unit;

FIG. 8 is a perspective view illustrating a structure of a stand mount included in the backlight unit;

FIG. 9 is a plane view illustrating connection between the chassis and the stand;

FIG. 10 is a cross-sectional view of the backlight unit along line A-A in FIG. 9;

FIG. 11 is a perspective view illustrating a circuit board mounted to a stand mount;

FIG. 12 is a rear view illustrating a construction of a circuit board assembly prepared by mounting various circuit boards to the stand mount;

FIG. 13 is a rear view illustrating a construction of a circuit board assembly according to the second embodiment of the present invention;

FIG. 14 is a perspective view illustrating connection between a rail and a reinforcement member; and

FIG. 15 is a rear view illustrating a circuit board assembly according to the third embodiment of the present invention.

### BEST MODE FOR CARRYING OUT THE INVENTION

### First Embodiment

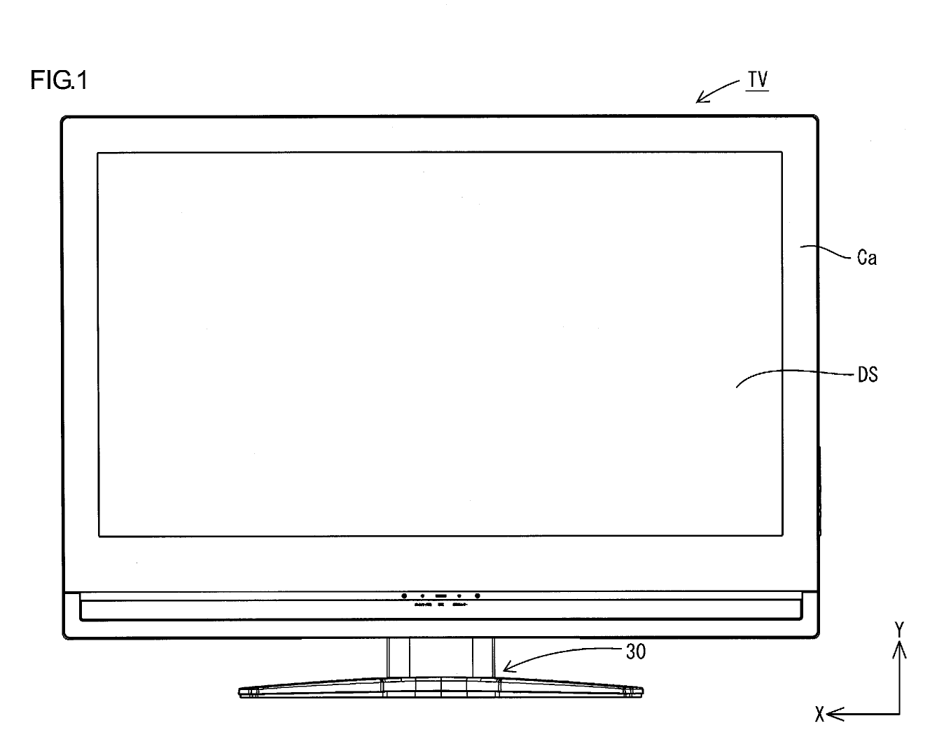

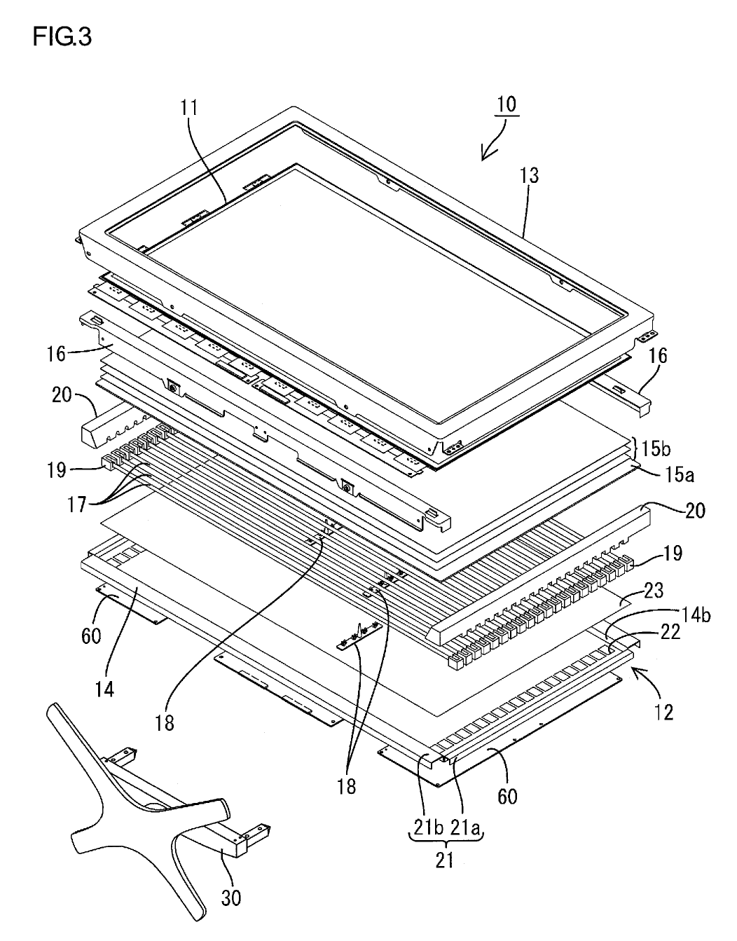

The first embodiment of the present invention will be explained with reference to FIGS. 1 to 12. In this embodiment, a liquid crystal display device 10 including a liquid crystal panel 11 will be explained. X-axes and Y-axes in some figures indicate horizontal and vertical directions, respectively. In FIGS. 3 to 5, the top and the bottom correspond to the front and the rear of the liquid crystal display device 10, respectively.

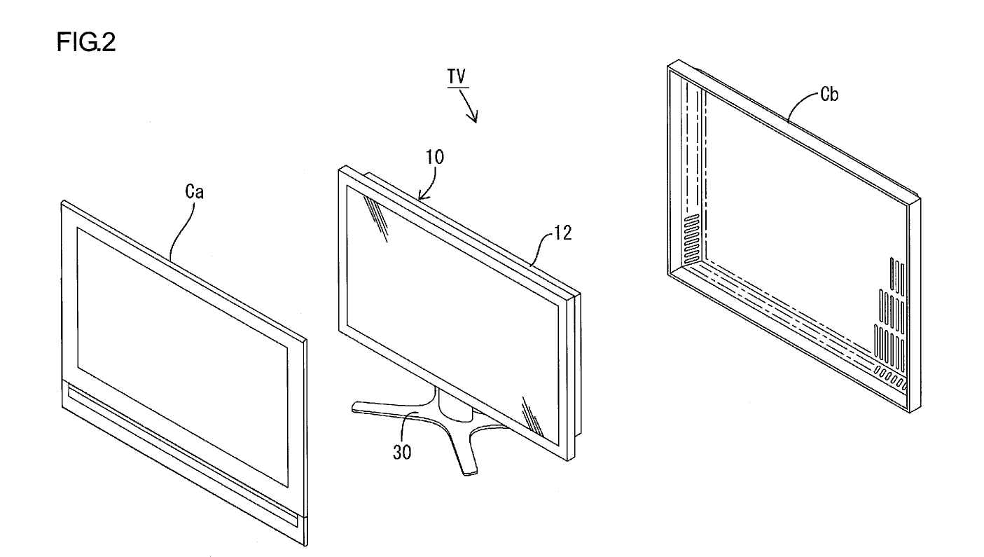

As illustrated in FIGS. 1 and 2, a television receiver TV of this embodiment includes the liquid crystal display device 10, front and rear cabinets Ca, Cb that house the liquid crystal display device 10 therebetween, and various circuit boards 60 to 63, which will be explained later. An overall shape of the liquid crystal display device (a display device) 10 is a landscape rectangular. The liquid crystal display device 10 is set in a vertical position (i.e., a standup position or a uprising position). As illustrated in FIG. 3, the liquid crystal display device 10 includes a liquid crystal panel 11, which is a display panel, and a backlight unit 12 (a lighting device), which is an external light source. They are held together by a bezel 13. As illustrated in FIG. 1, the television receiver TV has a configuration in which a display surface DS (a display surface of the liquid crystal panel 11) on which TV images are displayed is held at a specified vertical position with a stand 30 included in the backlight unit 12. A viewer sees TV images on the display surface DS set along the vertical direction (the Y-axis direction in FIG. 1) with a line of sight parallel to a horizontal plane.

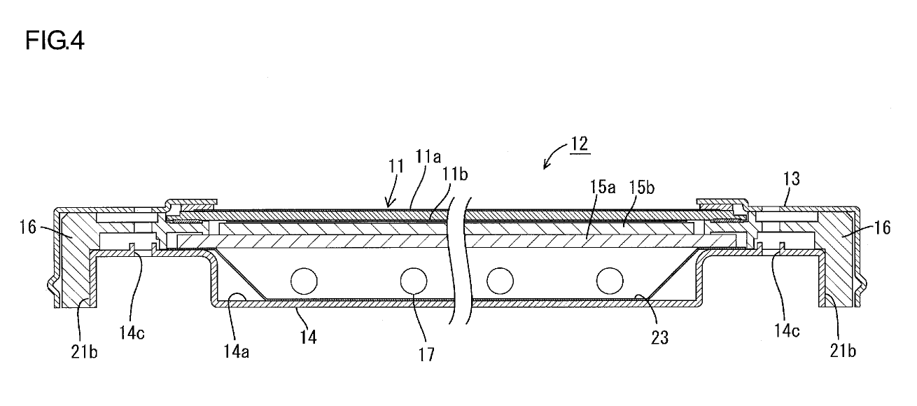

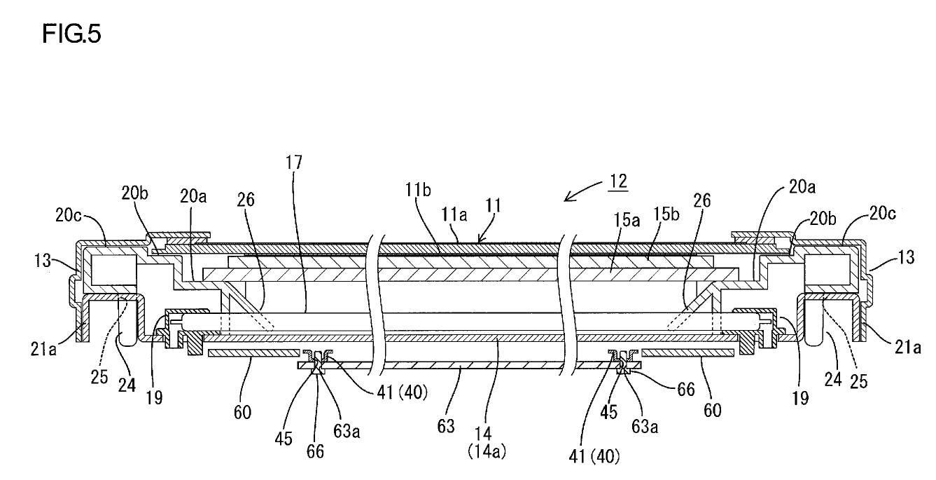

Next, the liquid crystal panel 11 and the backlight unit 12 included in the liquid crystal display device 10 will be explained. The liquid crystal panel (a display panel) 11 has a pair of glass substrates bonded together with a predetermined gap therebetween and liquid crystals sealed between the substrates. On one of the glass substrate, switching components (e.g., TFTs) connected to source lines and gate lines that are perpendicular to each other, pixel electrodes connected to the switching components and an alignment film are provided. On the other glass substrate, a color filter having red (R), green (G) and blue (B) color sections arranged in a predetermined matrix, a counter electrode and an alignment film are provided. Image data that is necessary for displaying an image and various control signals are sent from a drive circuit (not shown) to the source lines, the gate lines and the counter electrode. Polarizing plates 11a and 11b arranged on the outer surfaces of the glass substrates, respectively (see FIGS. 4 and 5).

As illustrated in FIG. 3, the backlight unit 12 includes a chassis 14, a diffuser plate 15a, a plurality of optical sheets 15b and frames 16. The chassis 14 has a landscape rectangular overall shape and an opening 14b in a surface on the light output side (i.e., on the liquid crystal panel 11 side). The diffuser plate 15a is attached to the chassis 14 so as to cover the opening 14b. The optical sheets 15b are arranged between the diffuser plate 15a and the liquid crystal panel 11. The frames 16 are arranged along the long sides of the chassis 14, respectively. The long-side edges of the diffuser plate 15a are held between the chassis 14 and the frame 16. A stand 30 is provided around the middle of one of the long sides of the chassis 14. The stand 30 holds the chassis 14 in the vertical position along the vertical direction. Cold cathode tubes (light sources) 17, lamp clips 18, relay connectors 19 and holders 20 are arranged inside the chassis 14. The lamp clips 18 are provided for mounting the cold cathode tubes 17 to the chassis 14. The relay connectors 19 are provided at the respective ends of the cold cathode tubes 17 to make electrical connection. The holders 20 collectively cover the relay connectors 19 at the respective ends of the cold cathode tubes 17. In the backlight unit 12, the diffuser plate 15a side with respect to the cold cathode tubes 17 is a light output side.

The chassis 14 is made of aluminum and formed in a substantially shallow box shape including a rectangular bottom plate 14a and folded outer rims 21 (short-side folded outer rims 21a and long-side folded outer rims 21b). Side plates standing upright from respective edges of the bottom plate 14a are folded into substantially U shapes to form the folded outer rims 21 by sheet-metal processing. In this embodiment, the chassis 14 is made of aluminum for a weight reduction purpose. However, if higher bending strength is required, the chassis 14 may be made of other metal material such as iron-based material.

The bottom plate 14a of the chassis 14 has a plurality of mounting holes 22 at the ends of the long dimension of the bottom plate 14a. The mounting holes 22 are through holes for mounting the relay connectors 19 to the chassis 14. As illustrated in FIG. 4, fixation holes 14c are provided in top surfaces of the long-side folded rims 21b of the chassis 14. The fixation holes 14c are through holes into which screws are inserted to bind the bezel 13, the frames 16 and the chassis 14 together.

A light reflecting sheet 23 is disposed on an inner surface side of the bottom plate 14a of the chassis 14a (a side facing the cold cathode tubes 17). The light reflecting sheet 23 is made of synthetic resin and has a surface in white color that provides high light reflectivity. It is disposed so as to cover about an entire inner surface of the bottom plate 14a of the chassis 14. As illustrated in FIG. 4, the long-side-edge sections of the light reflecting sheet 23 are raised so as to cover the respective long-side folded rims 21b of the chassis 14 and sandwiched between the chassis 14 and the diffuser plate 15a. Light emitted from the cold cathode tubes 17 are reflected toward the diffuser plate 15a by the light reflecting sheet 23.

The diffuser plate 15a and the optical sheet 15b are arranged on the opening 14b side of the chassis 14. The diffuser plate 15a includes a synthetic resin plate with light scattering diffusing particles that are scattered in the plate, and has a function for diffusing linear light emitted from the cold cathode tubes 17, which are tubular light sources. As described the above, the short-side edges of the diffuser plates 15a are placed on the first surfaces 20a of the holders 20 and no forces are applied to the short-side edges in the plate-thickness direction. As illustrated in FIG. 4, the long-side edges of the diffuser plate 15a are sandwiched between the chassis 14 (or the light reflecting sheet 23) and the frame 16, and fixed.

The optical sheet 15b arranged on the front side of the diffuser plate 15a includes a diffuser sheet, a lens sheet and a reflection-type polarizing plate layered in this order from the diffuser plate 15a side. It converts the light emitted from the cold cathode tubes 17 and passed through the diffuser plate 15a into a planar light. The liquid crystal panel 11 is arranged in front of the optical sheet 15b. The optical sheet 15b is sandwiched between the diffuser plate 15a and the liquid crystal panel 11.

Each of the cold cathode tubes 17 has an elongated tubular shape. A plurality of the cold cathode tubes 17 are arranged parallel to each other such that the length direction thereof (or the axial direction thereof) matches the long-side direction of the chassis 14 (see FIGS. 3 and 5). Each cold cathode tube 17 is held with the lamp clips 18 (not shown in FIG. 5) with a small gap between the bottom plate 14a of the chassis 14 (or the light reflecting sheet 23) and the cold cathode tube 17. Each end of the cold cathode tube 17 is fitted in the relay connector 19. The holders 20 are mounted so as to cover the relay connectors 19.

The holders 20 that cover the ends of the cold cathode tubes 17 are made of synthetic resin in white. As illustrated in FIG. 3, each of them has an elongated substantially box shape that extends in the short-side direction of the chassis 14. As illustrated in FIG. 5, each holder 20 has steps on the front side such that the diffuser plate 15a and the liquid crystal panel 11 are held at different levels. A part of the lamp holder 20 is placed on top of a part of the corresponding short-side outer rim 21a of the chassis 14 and forms a side wall of the backlight device 12 together with the short-side outer rim 21a. Insertion pins 24 project from a surface of the lamp holder 20 that faces the outer rim 21a of the chassis 14. The lamp holder 20 is mounted to the chassis 14 by inserting the insertion pins 24 into insertion holes 25 provided in the top surface of the short-side outer rim 21a of the chassis 14.

The steps of each lamp holder 20 include three steps, surfaces of which are parallel to the bottom plate of the chassis 14. The short-side edge of the diffuser plate 15a is placed on the surface of the first step 20a located at the lowest level. A sloped cover 26 extends from the first step 20a toward the bottom plate 14a of the chassis 14. The short-side edge of the liquid crystal panel 11 is placed on the surface of the second step 20b. The surface of the third step 20c located at the highest level is provided so as to overlap the short-side outer rim 21a of the chassis 14 and comes in contact with the bezel 13.

Next, the rear-surface side of the backlight unit 12 (a side of the chassis 14 opposite from the side on which the cold cathode tubes 17 are arranged) will be explained. On the rear-surface side of the backlight unit 12, a mounting structure of the stand 30 for holding the liquid crystal display device 10 (or the chassis 14) in the vertical position is provided. Moreover, various circuit boards 60 to 63 are arrange on that side. When the liquid crystal display device 10 is in the vertical position, the chassis 14 of the backlight unit 12 is in the vertical position, that is, the plate surface of the bottom plate 14a is set along the vertical direction. Moreover, the short-side rims 21a (i.e., the short dimension thereof) are set in the vertical direction and the long-side rims 21b (i.e., the long dimension thereof) are set in the horizontal direction.

First, the stand 30 and the mounting structure thereof will be explained in detail. The stand 30 is mounted to the lower long-side rim 21b of the chassis 14 via a stand mount 40 and covers 50 directly fixed to the chassis 14.

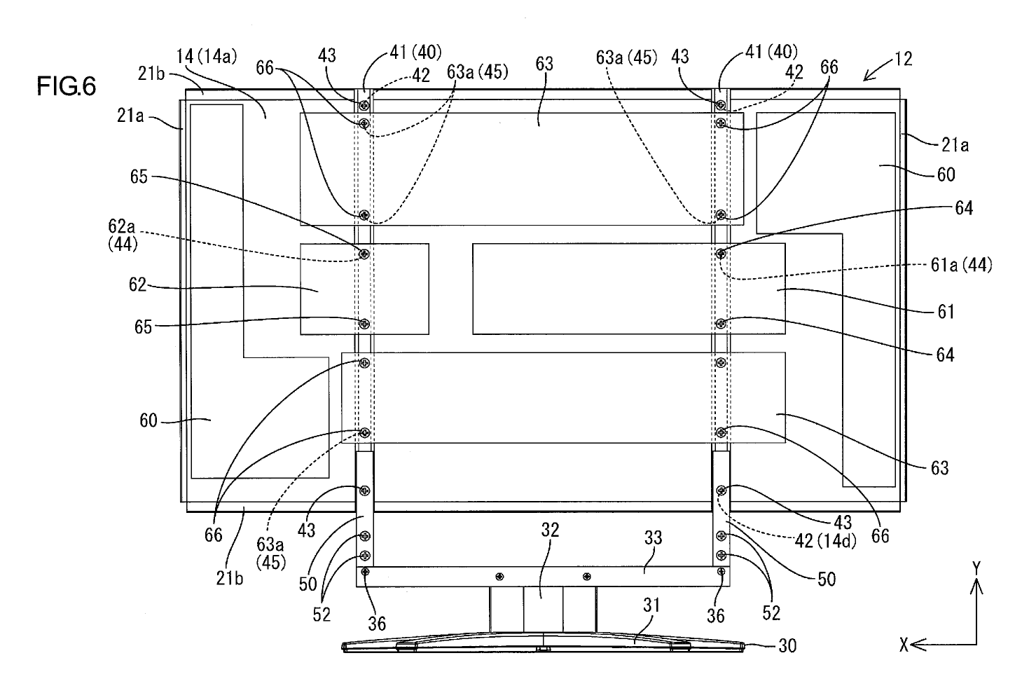

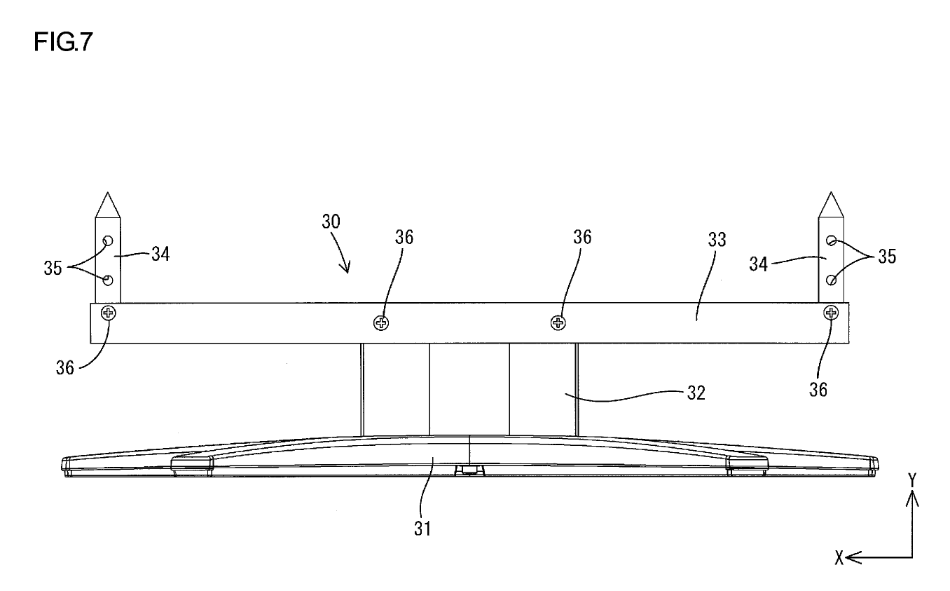

As illustrated in FIG. 7, the stand 30 includes a base 31, posts 32, a support base 33 and a pair of supports 34. The base 31 is directly placed on an installation surface on which the liquid crystal display device 10 is installed. The posts 32 rise from the base 31 in the vertical direction. The support base 33 that extends along the long side of the chassis 14 (i.e., the horizontal direction) is fixed to the distal ends of the posts 32. The supports 34 rise from the respective ends of the support base 33 in the vertical direction. The posts 32 and the supports 33 are arranged such that the axes thereof are set along the vertical direction (the Y-axis direction in FIG. 7). Each part of the stand 30 has a fitting structure and the parts of the stand 30 are fitted temporarily. The parts of the stand 30 are tightly fixed with screws 36. The stand 30 are mounted to the chassis 14 such that the posts 32 are positioned around the middle of the long side of the chassis 14 and the axis of the support base 33 matches the long-side direction of the chassis 14 (see FIG. 6).

Each of the supports 34 is a square pole having a substantially square horizontal cross section and an end (an upper end) thereof is tapered so as to have a substantially triangular vertical cross section. Namely, each support 34 is a substantially square pole with a tip on the chassis 14 side. Moreover, the support 34 has insertion holes 35 that are through holes in which screws are inserted.

As illustrated in FIG. 6, the stand mount 40 to which the stand 30 is mounted includes a pair of rails 41 directly fixed to the bottom plate 14a of the chassis 14. Each rail 41 has a substantially pillar-like shape that extends roughly in a straight line in one direction. Each rail 41 is mounted to the bottom plate 14a of the chassis 14 such that the longitudinal direction (or the axial direction) thereof matches the short-side direction of the chassis 14, that is, the vertical direction. The rails 41 are positioned away from each other in the long-side direction of the chassis 14, that is, the horizontal direction. The rails 41 are arranged parallel to each other so as to be along the vertical direction and to correspond to the respective supports 34 of the stand 30 on the bottom plate 14a of the chassis 14. The distance between the rails 41 and the distance between the supports 34 are about equal.

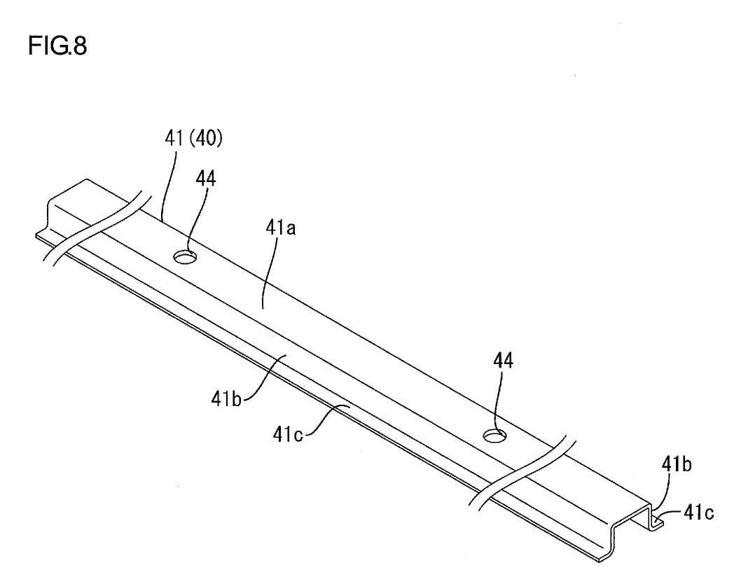

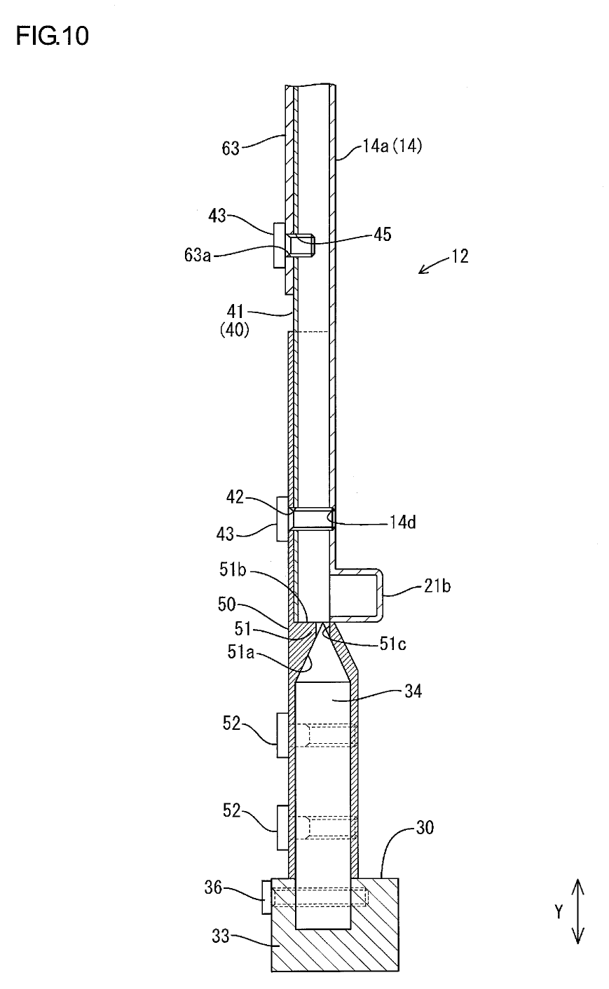

Each rail 41 is prepared by bending a metal plate, such as an iron plate. As illustrated in FIG. 8, each rail 41 includes a main-plate portion 41a, a pair of side-plate portions 41b and a pair of fringe portions 41c. The main-plate portion 41a has an elongated rectangular shape that extends along the vertical direction. The side-plate portions 41b project from the respective long edges of the main plate portion 41a toward the chassis 14. The fringe portions 41c project outward from the respective distal edges of the side-plate portions 41b along the rear surface of the chassis 14. The fringe portions 41 are formed such that the surfaces on the front side (i.e., the mounting surfaces mounted to the chassis 14) are on the same plane. Each rail 41 has an empty space defined by the main-plate portion 41a and the side-plate portions 41b. The main-plate portion 41a has insertion holes 42 that are through holes in which the screws 43 are inserted for mounting the rail 41 to the chassis 14. The insertion holes 42 are formed near the ends of the main-plate portion 41a in the vertical direction (see FIG. 6). The bottom plate 14a of the chassis 14 has screw holes 14d that are through holes provided at positions corresponding to the insertion holes 42 (see FIG. 10). The screws 43 are inserted in the screw holes 14d and fixed. The long dimension of each rail 41 is about the same as that of the short dimension of the chassis 14. Each rail 41 is mounted such that the ends of the long dimension thereof are located on the long-side edges of the chassis 14. Namely, each rail 41 extends from the long-side rim 21b located at the top to the other long-side rim 21b located at the bottom (see FIG. 6).

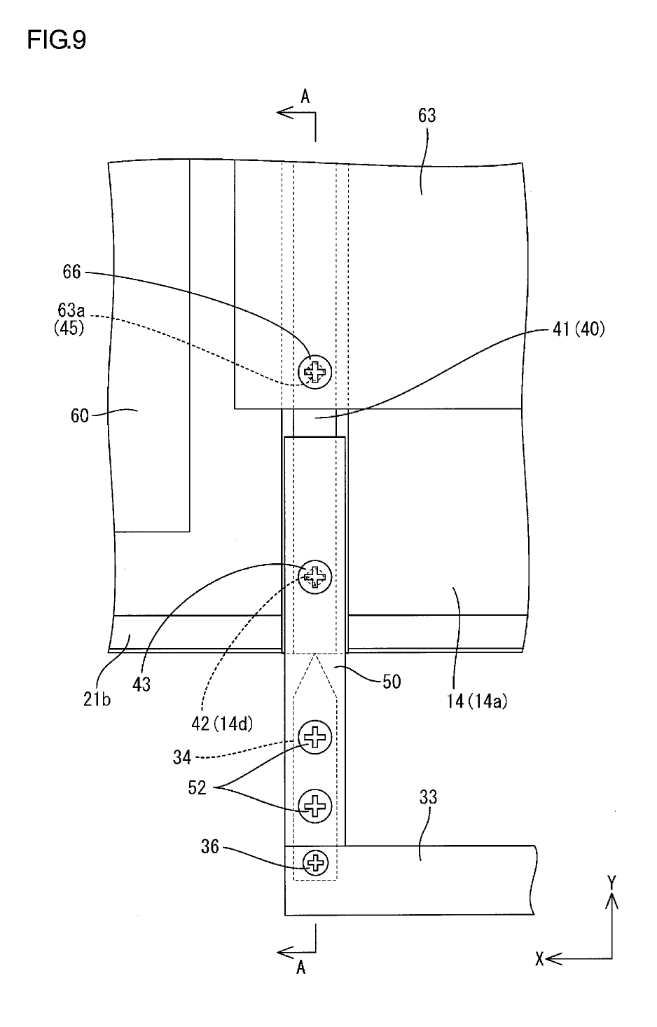

The covers 50 are made of synthetic resin and provided one for each support 34. As illustrated in FIG. 9, the covers 50 are mounted to the lower portions of the rails 41 of the stand mount 40 and the supports 34 so as to cover them. Specifically, each cover 50 covers the main-plate portion 41a and the side-plate portion 41b of the corresponding rail 41. It also covers about the entire area of the corresponding support 34 (including the rear-surface side). As illustrated in FIG. 10, each cover 50 has a protrusion 51. The protrusion 51 protrudes inward at a position that overlaps the tip of the support 34. The lower part of the protrusion 51 (facing the support 34) is a tapered portion 51a that is tapered in a shape corresponding to the tip of the support 34. When the tip of the support 34 is fitted in the tapered portion 51a, the support 34 and the cover 50 are fixed together. With such a fitting structure, connection strength between the support 34 and the cover 50 increases. The upper part of the cover 50 (facing the rail 41) has a flat surface 51b and the rail 41 is placed on the flat surface 51b. Moreover, a protrusion 72 has a through hole 51c that continues from the tapered portion 51a to the flat surface 51b. The support 34 and the rail 41 face (or in contact with) each other through the through hole 51c.

Each cover 50 and the corresponding support 34 are connected together with the screw 43 that is inserted from the front side of the cover 50 (from the left side in FIG. 10) and fixed at the rear side of the chassis 14. Each rail 41 and the corresponding support 34 are connected (or interlocked) to each other via the cover 50.

Next, the circuit boards 60 to 63 mounted to the rear surface of the chassis 14 will be explained. As illustrated in FIG. 6, the circuit boards 60 to 63 are specifically a pair of inverter boards 60, a power circuit board 61, an image processing circuit board 62 and a pair of control circuit boards 63. The circuit boards 60 to 63 have synthetic resin substrates with various electronic components mounted thereon.

Each inverter board 60 has a function for converting the power supplied by the power circuit board 61, which will be explained next, to a suitable form for driving the cold cathode tubes 17. It is electrically connected to the cold cathode tubes 17 via the relay connectors 19. The inverter boards 60 are arranged on the outer surface of the bottom plate 14a of the chassis 14 (on the surface on a side opposite from the cold cathode tubes 17) at ends of the long sides (along the X-axis direction) of the bottom plate 14a. They are arranged in outer area of the bottom plate 14a than the rails 41. Namely, the inverter boards 60 are arranged such that a space for mounting other circuit boards 61 to 63 are provided in the middle area of the bottom plate 14a in the horizontal direction (i.e., the X-axis direction) between the inverter boards 60. Each inverter board 60 has a wide area at one of the ends in the vertical direction (i.e., the Y-axis direction). The wide areas of the inverter boards 60 are arranged symmetrical with respect to a point so as to be upside down to each other in FIG. 6.

The power circuit board 61 is electrically connected to the inverter boards 60, the image processing circuit board 62 and the control circuit boards 63 via relay harnesses (not shown). Power is supplied to the cold cathode tubes 17 of the backlight unit 12 and to the liquid crystal panel 11 via the circuit boards 60, 62 and 63. The power circuit board 61 is located between the inverter circuit boards 60 in the horizontal direction (i.e., the X-axis direction). It is arranged at a position that crosses the right rail 41 in FIG. 6 and around the center of the chassis 14 in the vertical direction (the Y-axis direction) corresponding to an area between the control circuit boards 63, which will be explained later.

The image processing circuit board 62 includes a tuner (a receiver) for receiving TV signals (not shown) and has a function for processing the TV signals received by the tuner for image display. The image processing circuit board 62 is located between the inverter boards 60 in the horizontal direction (i.e., the X-axis direction). It is arranged in a position that crosses the left rail in FIG. 6 and around the middle of the chassis 14 in the vertical direction (i.e., the Y-axis direction), that is, at about the same vertical location as the power circuit board 61. The image processing circuit board 62 has about the same vertical dimension as the power circuit board 61. However, the horizontal dimension thereof is smaller than that of the power circuit board 61, which is about ⅓ of the horizontal dimension of the power circuit board 61.

The control circuit boards 63 are electrically connected to the image processing circuit board 62 and a drive circuit board (not shown) for the liquid crystal panel 11 via the relay harnesses (not shown). The control circuit boards 63 have functions for correcting image data input from the image processing circuit board 62 suitable for liquid crystal panel 11 and outputting the image data and control signals to the drive circuit for the liquid crystal panel 11. The control circuit boards 63 are located between the inverter boards 60 so as to extend over the rails 41 in the horizontal direction (i.e., the X-axis direction). They are located near the respective sides of the chassis 14 in the vertical direction (i.e., the Y-axis direction), that is, the power circuit board 61 and the image processing circuit board 62 are located between the control circuit boards 63. The horizontal dimensions of the control circuit boards 63 are larger than the distance between the rails 41. Moreover, each control circuit board 63 is arranged so as not to overlap the inverter boards 60 next to it by positioning it with the vertical location thereof substantially aligned to the wide areas of either one of the inverter boards 60. The upper control circuit board 63 sends image data and control signals related to images on the upper half of the screen to the drive circuit board for the liquid crystal panel 11. The lower control circuit board 63 sends image data and control signals related to images on the lower half of the screen to the drive circuit. The lower control circuit board 63 does not overlap the covers 50 and the supports 34 in plan view, that is, it is vertically shifted from them.

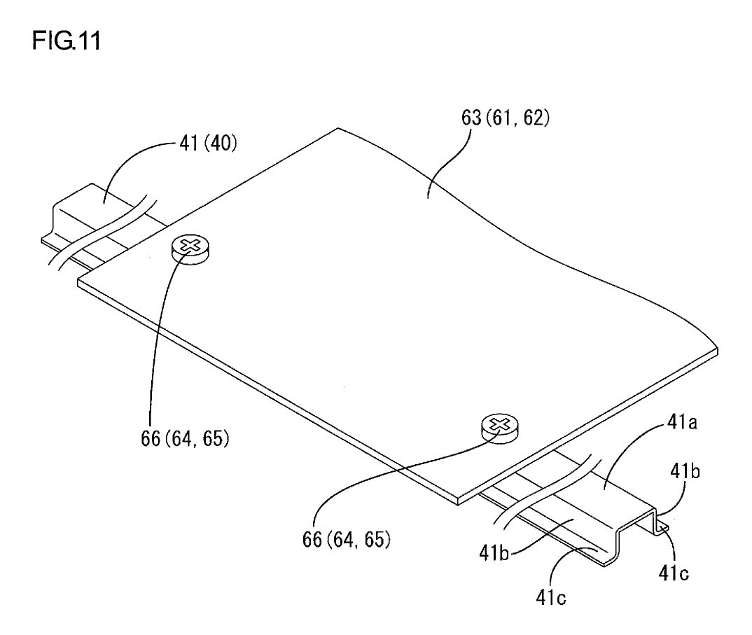

The inverter boards 60 among the circuit boards 60 to 63 are directly fixed to the chassis 14 as illustrated in FIG. 6. The power circuit board 61, the image processing circuit board 62 and the control circuit boards 63 are directly fixed to the stand mount 40 (see FIG. 11). They are indirectly fixed to the chassis 14 via the stand mount (see FIG. 10).

Specifically, parts of the power circuit board 61 and the image processing circuit board 62, which overlaps the respective rails 41 in plan view, have pairs of insertion holes 61a and 62a, respectively. The insertion holes 61a and 62a are through holes in which the screws 64 and 65 are inserted to fix the power circuit board 61 and the image processing circuit board 62. The insertion holes 61a and 62a are arranged near the ends of the long dimensions of the circuit boards 61 and 62, respectively. The main-plate portion 41a of each rail 41 has a screw hole 44 at a position corresponding to the insertion hole 61a or 62a in which the screw 64 or 65 is inserted and tightened.

The control circuit boards 63 have insertion holes 63a in which screws 66 are inserted to fix the control circuit boards 63. Four insertion holes 63a are provided in each control circuit board 63. They are arranged near the ends of long and short dimensions of the control circuit board 63. The main-plate portion 41a of each rail 41 of the stand mount 40 has four screw holes 45 in which the screws 66 are inserted and tightened at locations corresponding to the respective insertion holes 63a. The screw holes 45 are formed in the rails 41 between the insertion holes 42 in which the screws 43 for mounting the rails 41 to the chassis 14 are inserted with respect to the vertical direction.

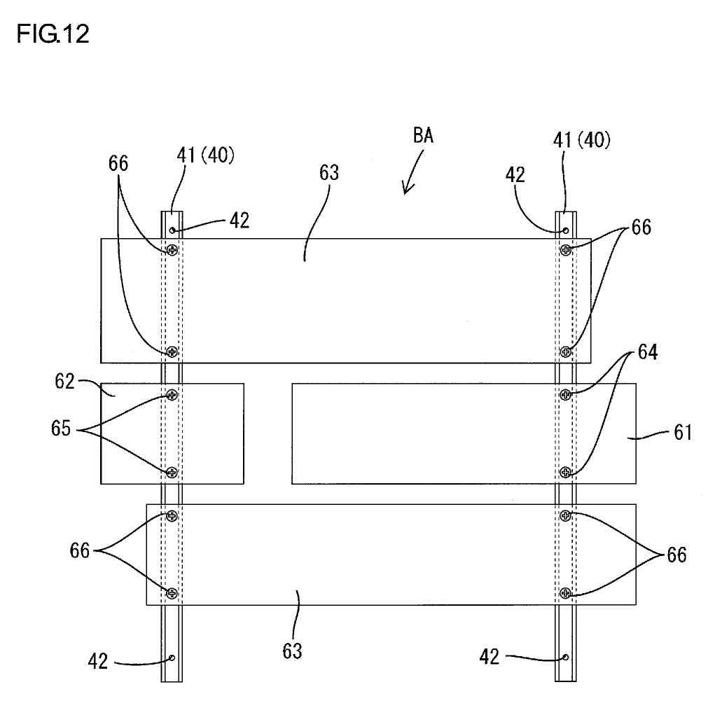

With the above-described fixation structures, the power circuit board 61, the image processing circuit board 62 and the control circuit boards 63 are directly mounted to the rails 41, which are parts of the stand mount 40, without mounting to the chassis 14 or the stand 30. Prior to the mounting of the stand 30, the rails 41 and other parts to the chassis 14, the power circuit board 61, the image processing circuit board 62 and the control circuit boards 63 are directly fixed to the rails 41 to prepare them as a single assembly. This assembly will be referred to as a circuit board assembly BA (see FIG. 12) hereinafter.

This embodiment has the above configurations, and an example of steps of manufacturing the television receiver will be explained next. In the manufacturing process of the television receiver TV, the liquid crystal panel 11, the backlight unit 12 and the bezel 13 prepared in different processes are assembled into the liquid crystal display device 10. Then, the cabinets Ca and Cb and other parts are mounted to the liquid crystal display device 10. Steps of manufacturing of the backlight unit 12 will be explained in detail.

Manufacturing of the backlight unit 12 is complete when a chassis assembly process in which various parts are mounted to the chassis 14 is complete. In this embodiment, a circuit board assembly process in which the circuit boards 61 to 63 are mounted to the stand mount 40 is performed prior to the chassis assembly process.

Specifically, the light reflecting sheet 23, the lamp clips 18, the cold cathode tubes 17, the relay connectors 19, the holders 20, the optical members 16a and 16b, and the frame 16 are mounted to the front surface of the bottom plate 14a of the chassis 14 in the chassis assembly process. Further in the chassis assembly process, the inverter boards 60, the stand mount 40 to which the circuit boards 61 to 63 except for the inverter boards 60 are mounted, the covers 50 and the stand 30 are mounted to the rear surface of the bottom plate 14a of the chassis 14 (see FIGS. 4 and 5). In the chassis assembly process, the chassis 14 is passed from the start to the end of the production line by a conveyer (not shown) provided along the production line. In the production line, the parts are mounted to the chassis 14 in the predetermined sequence at the respective work areas along the production line.

In the circuit board assembly process, the power circuit board 61, the image processing circuit board 62 and the control circuit boards 63 are mounted to the rails 41 of the stand mount 40 to prepare the circuit board assembly BA illustrated in FIG. 12. In this process, the circuit boards 61 to 63 are plated on at least one of the rear surfaces of the main-plate portions of the rails 41 and aligned such that the insertion holes 61a to 63a of the circuit boards 61 to 63 match the respective screw holes 44 and 45 of the rails 41. Then, the screws 64 to 66 are inserted in the screw holes 44 and 45, and tightened.

The circuit board assembly process is performed prior to at least the steps of mounting the stand mount 40 to the chassis 14 in the chassis assembly process and in the separate production line from the chassis assembly process. Because the circuit boards 61 to 63 except for the inverter board 60 are mounted to the stand mount 40 and the stand mount is mounted to the chassis 14 in the chassis assembly process, steps of mounting the circuit boards 61 to 63 to the chassis 14 are not required. Namely, the stand mount 40 and the circuit boards 61 to 63 are mounted to the chassis 14 at the same time by mounting the circuit board assembly BA to the chassis 14 in the chassis assembly process. The work areas for mounting of the circuit boards 61 to 63 are not required in the production line for the chassis assembly process. Therefore, the production line for the chassis assembly process can be shortened and the production efficiency can be improved.

When mounting the circuit board assembly BA, the covers 50 and the stand 30 to the chassis 14, the circuit board assembly BA is mounted to the chassis 14 is mounted first, and the covers 50 and the stand 30 are mounted to the chassis 14 in this sequence. However, the sequence of the steps can be altered as necessary. For example, the stand 30 is mounted to the covers 50 while the circuit board assembly BA is prepared in a different production line from the production line for the chassis assembly process, and the circuit board assembly BA and the stand assembly (not shown) are mounted to the chassis 14 in the chassis assembly process.

When the backlight unit 12 is prepared after the completion of the chassis assembly process, the liquid crystal panel 11 and the bezel 13 are mounted to the backlight unit 12. Then, the liquid crystal display device 10 is prepared. The television receiver TV is produced when the cabinets Ca and Cb are mounted to the liquid crystal display device 10.

As described the above, the backlight unit 12 includes the cold cathode tubes 17, the chassis 14, the stand 30, the stand mount 40 and the circuit boards 61 to 63. The chassis 14 houses the cold cathode tubes 17. The stand 30 holds the chassis 14. The stand mount 40 is fixed to the surface of the chassis 14 located on the side opposite from the cold cathode tubes 17. The stand 30 is mounted to the stand mount 40. The circuit boards 61 to 63 are directly fixed to the stand mount 40.

The stand mount 40 and the circuit boards 61 to 63 are prepared as a single assemble by fixing the circuit boards 61 to 63 directly to the stand mount 40 prior to the mounting steps of the stand 30 and the stand mount 40 to the chassis 14. Therefore, steps of mounting the circuit boards 61 to 63 to the chassis 14 are not required and thus the production line can be shortened and the production efficiency can be improved.

In comparison to a configuration in which a dedicated part for assembling the circuit boards 61 to 63 into a single assembly other than the stand mount 40 is fixed to the chassis 14, weight, thickness and cost can be reduced because the configuration of this embodiment does not have such a dedicated part.

The stand 30 holds the chassis 14 in the vertical position. The stand mount 40 includes the rails 41 arranged such that the longitudinal directions thereof match the vertical direction of the chassis 14. The chassis 14 in the vertical position is effectively reinforced with the rails 41 arranged along the vertical direction and thus less likely to be skewed. The vertical direction here corresponds to the top-to-bottom direction of the backlight unit 12 with the chassis 14 set in the vertical position.

If the chassis 14 that houses a plurality of the cold cathode tubes 17 is skewed, the distance between each cold cathode tube 17 and the chassis 14 may vary from one cold cathode tube 17 to another. If the chassis 14 is made of metal, a small amount of leak current from each cold cathode tube 17 to the chassis 14 exists. The amount of the leak current is in inverse proportion to the distance between the cold cathode tube 17 and the chassis 14. If the distance varies from one cold cathode tube 17 to another, the amount of light emitted from each cold cathode tube 17 also varies from one cold cathode tube 17 to another. As a result, the luminance of the backlight unit 12 may become nonuniform. With the rails that can effectively reinforce the chassis 14, the chassis 14 is less likely to be skewed and thus the above problem is less likely to occur.

The rails 41 are arranged away from each other and fixed to the chassis 14 such that the control circuit boards 63 among the circuit boards 61 to 63 extend over the rails 41. Therefore, the control circuit boards 63 are stably fixed. Because the chassis 14 is effectively reinforced with the rails 41, it is less likely to be skewed.

The circuit boards 61 to 63 includes the power circuit board 61 that supplies power to the cold cathode tubes 17. Therefore, the power circuit board 61 and the stand mount 40 are prepared as a single assembly.

The stand mount 40 is made of metal. Therefore, high bending strength of the stand mount 40 can be achieved and thus the stand mount 40 is suitable for reinforcements of the chassis 14.

The stand mount 40 has a hollow structure and thus contributes to weight reduction.

The liquid crystal display device 10 of this embodiment includes the above backlight unit 12 and the liquid crystal panel 11 that provides display using light from the backlight unit 12. Because the production line for the backlight unit 12 is shortened and the production efficiency thereof is improved, the production cost of the liquid crystal display device 10 can be reduced.

The circuit boards 61 to 63 include the power circuit board 61 that is configured to supply power to the liquid crystal panel 11. The power circuit board 61 and the stand mount 40 are prepared as a single assembly. Furthermore, the circuit boards 61 to 63 include the control circuit boards 63 configured to control driving of the liquid crystal panel 11. The control circuit boards 63 and the stand mount 40 are prepared as a single assembly.

The television receiver TV of this embodiment includes the above liquid crystal display device 10 and the tuner (the receiver) that is configured to receive TV signals. Because the production cost of the liquid crystal display device 10 is reduced, that of the television receiver TV can be also reduced.

The circuit boards 61 to 63 include the image processing circuit board 62. Therefore, the image processing circuit board 62 and the stand mount 40 are prepared as a single assembly.

The method of manufacturing the backlight unit 12 of this embodiment includes the chassis assembly process. In the chassis assembly process, the stand 30 for holding the chassis 14 and the stand mount 40 are mounted to the chassis 14 that houses the cold cathode tubes 17. The stand mount 40 is fixed to the surface of the chassis 14 located on the side opposite from the cold cathode tubes 17 and the stand 30 is mounted to the stand mount 40. Prior to the chassis mounting process, the circuit board assembly process is performed. In the circuit board assembly process, the circuit boards 61 to 63 are directly fixed to the stand mount 40 and prepared the circuit boards 61 to 63 and the stand mount 40 as a single assembly.

By performing the circuit board assembly process prior to the chassis assembly process, the stand mount 40 and the circuit boards 61 to 63 are prepared as a single assembly by directly fixing the circuit boards 61 to 63 to the stand mount 40. Therefore, the steps of mounting the circuit boards 61 to 63 to the chassis 14 are not required in the chassis mounting process and thus the production line can be shortened and the production efficiency can be improved.

### Second Embodiment

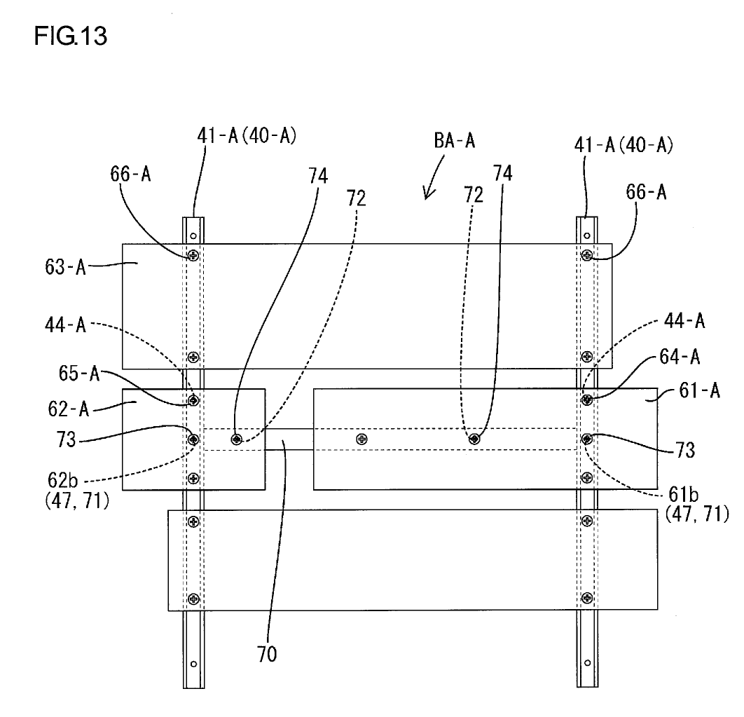

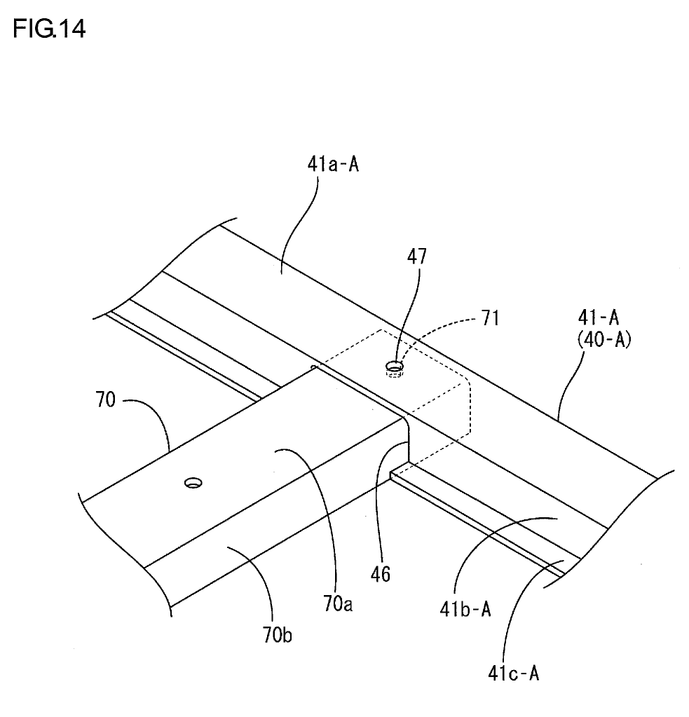

The second embodiment of the present invention will be explained with reference to FIGS. 13 and 14. In this embodiment, a stand mount 40-A (a chassis) has an additional reinforcement structure. The same parts as the first embodiment are indicated by the same symbols followed by “-A.” The same structures, functions and effects will not be explained.

As illustrated in FIG. 13, the stand mount 40-A includes a pair of rails 41-A and a reinforcement member 70 is bridged from one of the rails 41-A to the other rail 41-A. The reinforcement member 70 is set in a position such that the longitudinal direction thereof is perpendicular to the longitudinal direction of the rails 41-A (i.e., the vertical direction). Namely, the reinforcement member 70 is set in the horizontal position. Ends of the reinforcement member 70 are fixed to the respective rails 41-A so as to form a beam structure between the rails 41-A. The reinforcement member 70 is arranged around the middle of the long dimensions of the rails 41-A such that the power circuit board 61-A and the image processing circuit board 62-A overlap the reinforcement member 70 in plan view. The rails 41-A and the reinforcement member 70 that connect the rails 41-A form an H shape in plan view. The reinforcement member 70 is prepared by bending a metal plate, such as an iron plate, into a shape having a substantially C-shaped cross section. As illustrated in FIG. 14, the reinforcement member 70 has a main-plate portion 70a that extends in the horizontal direction and side-plate portions 70b that extend from the respective long-side edges of the main-plate portion 70a toward the front. Namely, the reinforcement member 70 has a hollow structure having an empty space defined by the main-plate portion 70a and the side-plate portions 70b.

Among the side-plate portions 41b-A and the fringe portions 41c-A of each rail 41-A, the inner side-plate portion 41b-A and the inner fringe portion 41c-A (facing the other rail 41-A) has a cutout 46 as illustrated in FIG. 14. The end of the reinforcement member 70 is inserted in the cutout 46. The main-plate portion 41a-A of each rail 41-A has am insertion hole 47 in which a screw 73 for fixing the reinforcement member 70 is inserted. The insertion hole 47 is a through hole arranged in an area that overlaps the reinforcement member 70 inserted in the cutout 46 in plan view. A screw hole 71 in which the screw 73 is inserted and fixed is provided in each end of the main-plate portion 71a of the reinforcement member 70 in an area that overlaps the insertion hole 47 in plan view.

As illustrated in FIG. 13, the power circuit board 61-A and the image processing circuit board 62-A are arranged so as to overlap the reinforcement member in plan view and directly fixed to the reinforcement member 70 with screws 73 and 74. Specifically, the reinforcement member 70 has a pair of screw holes 72 in an area that overlaps the power circuit board 61-A and another pair of screw holes 72 in an area that overlaps the image processing circuit board 62-A in addition to the screw holes 71 in the end areas. The power circuit board 61-A and the image processing circuit board 62-A have the insertion holes 61b and 62b, respectively. The insertion holes 61b and 62b are provided in areas that overlap the screw holes 71 and 72, respectively, in addition to areas that overlap screw holes 44-A of the rails 41-A. The screws 73 are inserted in the insertion holes 61b and 62b. The reinforcement member 70 is arranged so as to across the power circuit board 61-A and the image processing circuit board 62-A around the horizontal center lines of the circuit boards 61-A and 62A.

When preparing a circuit board assembly BA-A, the ends of the reinforcement member 70 is inserted into the cutouts 46 of the respective rails 41-A and temporarily fixed with a joint structure. Under this condition, the insertion holes 47 of the rails 41-A and the screw holes 71 of the reinforcement member 70 are aligned. Then, the circuit boards 61-A to 63-A are placed on the rails 41-A and the reinforcement member 70. The screw holes and the respective insertion holes are aligned. Under this condition, the screws 64-A, 66-A, 73 and 74 are tightened and the circuit boards 61-A to 63-A are fixed to the respective rails 41-A and the reinforcement member 70. The rails 41-A and the reinforcement member 70 are tightly fixed together and the circuit board assembly BA-A is prepared. The power circuit board 61-A and the image processing circuit board 62-A are fixed to the rails 41-A together with the reinforcement member 70 with the screws 73. The sequence of mounting the circuit boards 61-A to 63-A can be arbitrarily defined.

As described the above, the backlight unit of this embodiment includes the reinforcement member 70 bridged from one of the rails 41-A to the other rail 41-A. The chassis can be further reinforced with the reinforcement member 70 and is less likely to be skewed.

The power circuit board 61-A and the image processing circuit board 62-A among the circuit boards 61-A to 63-A are directly fixed to the reinforcement member 70. Because the power circuit board 61-A and the image processing circuit board 62-A are fixed not only to the respective rails 41-A but also to the reinforcement member 70, they are more stably fixed.

### Third Embodiment

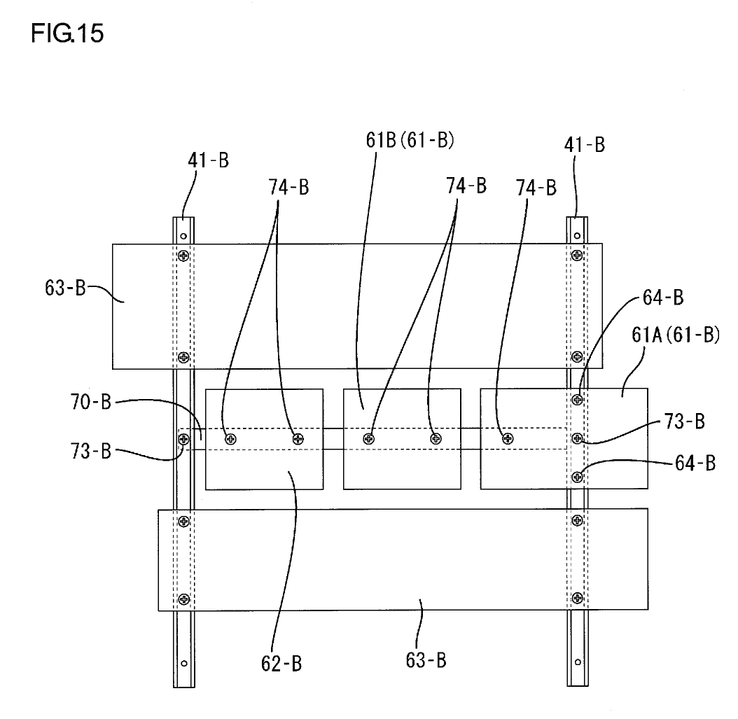

The third embodiment of the present invention will be explained with reference to FIG. 15. In this embodiment, circuit boards 61-B and 62-B are provided in different arrangement from the circuit boards in the second embodiment. The same parts as the second embodiment are indicated by the same symbols followed by “-B.” The same structures, functions and effects will not be explained.

As illustrated in FIG. 15, the power circuit board 61-B includes a main power circuit board 61A having a relatively large size and a sub power circuit board 61B having a relatively small size. The main power circuit board 61A and the sub power circuit board 61B are electrically connected to each other via relay harnesses (not shown). The main power circuit board 61A is arranged so as to overlap a rail 41-B and a reinforcement member 70-B in plan view. The sub power circuit board 61B is arranged so as to overlap only the reinforcement member 70-B in plan view. The main power circuit board 61A and the sub power circuit board 61B are arranged next to each other in the horizontal direction and parallel to each other with a predefined gap therebetween. A horizontal dimension of each of the main power circuit board 61A and the sub power circuit board 61B is smaller than the distance between the rails 41-B. The main power circuit board 61A is fixed to the rail 41-B and the reinforcement member 70-B with screws 64-B, 73-B and 74-B. The sub power circuit board 61B is fixed only to the reinforcement member 70-B with the screws 74-B. The image processing circuit board 62-B overlaps only the reinforcement member 70-B in plan view and is fixed to the reinforcement member 70-B with the screws 74-B. The horizontal dimension of the image processing circuit board 62-B is smaller than the distance between the rails 41-B.

As described the above, the circuit boards in small size among the circuit boards 61-B to 63-B are fixed only to the reinforcement member 70-B. This configuration is preferable when many small circuit boards 61A, 61B, 62-B are used.

### Other Embodiments

The present invention is not limited to the above embodiments explained in the above description. The following embodiments may be included in the technical scope of the present invention, for example.

(1) In the above embodiments, the stand mount includes two rails. However, the stand mount may include only one rail or more than two rails. The shape of the stand (or the number of the supports) may be altered as necessary.

(2) The shape of the rails may be altered as necessary. For example, each rail may have only one fringe on one side or no fringes and having a C-shape cross section. Alternatively, each rail may have only one side-plate portion on one side and have a L-shaped cross section, or have an elongated plate shape without side-plate portions.

(3) Each rail may have a solid structure without a hollow portion inside other than the hollow structure.

(4) In the above embodiments, the rails are mounted to the chassis with the longitudinal directions thereof in the vertical direction. However, rails mounted to the chassis with the longitudinal directions set along the horizontal direction or along a diagonal direction that crosses the horizontal direction and the vertical direction are included in the scope of the present invention.

(5) In the above embodiments, the rails are mounted to the chassis symmetric to each other. However, the rails asymmetically mounted to the chassis is also included in the scope of the present invention.

(6) In the above embodiments, the rails are made of metal. However, the rails may be made of different material such as synthetic resin.

(7) In the above embodiment, the stand mount including the rails is used as an example. However, a stand mount including other parts than the rails is included in the scope of the present invention.

(8) Circuit boards other than the above circuit boards may be directly fixed to the stand mount. For example, the inverter board may be directly mounted to the stand mount.

(9) The number of circuit boards that are directly fixed to the stand mount can be changed.

(10) All circuit boards arranged on the rear surface side of the backlight unit may be mounted to the stand mount and prepared as a single assembly.

(11) Different kinds or number of the circuit boards can be used in the backlight unit.

(12) Shapes and sizes of the circuit boards and mounting locations of the circuit boards in the stand mount (or the chassis) can be altered as necessary.

(13) In the second and the third embodiments, only one reinforce member is used. However, two or more reinforce members can be used. The reinforcement member may be formed in a different shape or mounted to different locations of the rails.

(14) In the above embodiments, the stand is mounted to the stand mount via the covers. However, a stand directly mounted to the stand mount without the covers is included in the scope of the present invention.

(15) In the above embodiments, the liquid crystal panel and the chassis are set in the vertical positions with the short sides thereof aligned to the vertical direction is explained as an example. However, the liquid crystal and the chassis set in the vertical positions with the long sides thereof aligned to the vertical direction are also included in the scope of the present invention.

(16) In the above embodiments, the chassis is constructed of a metal plate. However, it may be formed by molding.

(17) The cold cathode tubes are used in the above embodiments as linear light sources. However, hot cathode tubes or other types of liner light sources tubes can be used.

(18) The TFTs are used as switching components in the liquid crystal display device. The disclosed technologies can be applied to liquid crystal display devices that use switching components other than the TFTs, such as thin film diodes (TFDs). Furthermore, the technologies can be applied to black-and-white display devices other than color liquid crystal display devices.

(19) The liquid crystal display devices using the liquid crystal panels are used as examples in the above embodiments. However, the present invention can be applied to display devices using other types of display panels.

(20) The television receivers having tuners are used in the above embodiments. However, the present invention can be applied to display devices without tuners.

1. A lighting device comprising:
a light source;
a chassis housing the light source;
a stand holding the chassis;
a stand mount fixed to a surface of the chassis on a side opposite from the light source and to which the stand is mounted; and
at least one circuit board directly fixed to the stand mount.

2. The lighting device according to claim 1, wherein:
the chassis is held in a vertical position with the stand; and
the stand mount includes at least one rail arranged on the chassis with a longitudinal direction thereof aligned along a vertical direction of the chassis.

3. The lighting device according to claim 1, wherein:
the at least one rail includes a pair of rails arranged away from each other; and
the at least one circuit board are placed over the rails and fixed.

4. The lighting device according to claim 3, further comprising a reinforcement member bridging from one of the rails to the other rail.

5. The lighting device according to claim 4, wherein the at least one circuit board is directly fixed to the reinforcement member.

6. The lighting device according to claim 1, wherein the at least one circuit board includes a power circuit board configured to supply power to the light source.

7. The lighting device according to claim 1, wherein the stand mount is made of metal.

8. The lighting device according to claim 1, wherein the stand mount has a hollow structure.

9. A display device comprising:
the lighting device according to claim 1; and
a display panel configured to provide display using light from the lighting device.

10. The display device according to claim 9, wherein the at least one circuit board includes a power circuit board configured to supply power to the display panel.

11. The display device according to claim 9, wherein the at least one circuit board includes a control circuit board configured to control driving of the display panel.

12. The display device according to claim 9, wherein the display panel is a liquid crystal panel using liquid crystals.

13. A television receiver comprising:
the display device according to claim 9; and
a receiver configured to receive television signals.

14. The television receiver according to claim 13, wherein the at least one circuit board includes an image processing circuit board configured to process television signals input from the receiver for image display.

15. A method of manufacturing lighting devices, comprising:
a chassis assembly process for mounting a stand and a stand mount to a surface of a chassis that houses a light source, the surface being located on a side opposite from the light source, and the stand being provided for holding the chassis and to be mounted to the stand mount; and
a circuit board assembly process for directly fixing a circuit board to the stand mount to prepare the circuit board and the stand mount as a single assembly prior to the chassis assembly process.
